(19) United States
(12) Patent Application Publication
(10) Pub. No.: US 2009/0185959 A1
(43) Pub. Date: Jul. 23, 2009

(54) Distributed networked ozonation system

(76) Inventors: Michael Weber, Sunnyvale, CA (US); Barry Bowman, Dublin, CA (US); Michael Shannon, Hayward, CA (US); Andrew Volondin, Walnut Creek, CA (US); Howard Wang, Pleasanton, CA (US); Andrew Smith, Pleasanton, CA (US); Ray Hoobler, Pleasanton, CA (US)

Correspondence Address: CARR & FERRELL LLP, 2200 GENG ROAD, PALO ALTO, CA, 94303, US

(21) Appl. No.: 12/315,045

(22) Filed: Nov. 25, 2008

Related U.S. Application Data
(60) Provisional application No. 61/004,490, filed on Nov. 27, 2007.

(51) Int. Cl. B01J 19/08

(52) U.S. Cl. 422/107; 422/186.07

(57) ABSTRACT

Embodiments of the present invention provide a distributed networked ozonation system for ozonation of storage rooms containing fresh or perishable products, and also may be useful in other applications involving multiple ozonated zones. An exemplary embodiment uses a set of distributed ozone generators connected to a communication network. An exemplary ozone generator comprises an ozone sensor, an ozone-generating cell, and a controller, and also may comprise an air cooling unit with an ozone destruct air filter, so that the generator may be placed within an ozonated environment. The ozone level of the storage area may be under closed-loop feedback control. The controller may communicate with other controllers at the same site and with a site controller, which in turn may communicate with a remote controller.

### CROSS-REFERENCE TO RELATED APPLICATION

This application claims the benefit and priority of U.S. Provisional Patent Application Ser. No. 61/004,490 filed on Nov. 27, 2007, titled “Distributed Networked Ozonation System,” which is hereby incorporated by reference.

### BACKGROUND OF THE INVENTION

This invention relates to the storage of perishable plant products, and more specifically to ozonated storage.

### DESCRIPTION OF RELATED ART

Ozone currently is used as a disinfectant for air and water. For example, ozone may be applied to perishable products (such as agricultural and horticultural products) in storage. Perishable agricultural products, such as fresh harvested fruits, vegetables, and flowers, as well as frozen foods, are typically processed and stored in rooms at packers, processors, cold storage facilities or distribution centers in which a low temperature is maintained. These rooms are designed to preserve fresh and frozen produce and food products prior to or after transport by truck, rail, air, or ship. A storage facility, or site, may have one or more storage rooms.

Refrigerated shipping containers or trailers are commonly used to transport products from producers to consumers. They are similar to storage rooms, except that they are mobile. Products may be shipped to consumer retail facilities in such containers so that consumers may enjoy a wide variety of products year-round from many parts of the world. At these facilities, the products may also be stored in rooms or in areas (“zones”) at low temperatures to extend storage and shelf life.

Refrigeration is useful for preserving the freshness of agricultural products for extended periods. Refrigeration inhibits ripening, spoilage and the growth of microorganisms that lead to deterioration of the quality of the product. However, refrigeration only retards the growth of these microorganisms and does not destroy them. A significant portion of produce may be lost during transport or storage: statistics indicate that as much as twenty percent of all agricultural products shipped worldwide is lost to spoilage and rot.

In climacteric fruits and vegetables in particular, the decay process is a late stage of the ripening process stimulated by the self-emission of ethylene. If too much ethylene-stimulated ripening occurs prematurely, then the products often ripen to the point where they are unusable to the consumer and have to be discarded. This ripening process continues during transport, after the products leave the cold storage facilities, and on the retailer's shelf. Further, the ripening process may be initiated or accelerated by ethylene emitted by other commodities stored in the same facility. For example, when apples and kiwifruit are stored together, the ethylene produced by the apples can initiate the premature ripening of the kiwifruit. Even commodities that are not ethylene-producing, such as cherries, are negatively impacted by the presence of ethylene.

Currently, additional preservation of freshness can be accomplished by storing and transporting the products in a controlled atmosphere environment that slows respiration, ethylene emission, and ripening, thus leading to increased shelf life. In such a controlled atmosphere environment, the atmospheric air normally surrounding the products is replaced by a gas that contains a reduced oxygen level (generally, with a target level of about one to five percent, compared with about twenty-one percent in air) and an increased carbon dioxide level. In most cases, the carbon dioxide is produced by the respiration of the stored plant tissue, but it also may be provided by a carbon dioxide gas supply. The majority of the remaining gas in the controlled atmosphere environment is nitrogen.

Further protection may be obtained by exposing the products to ozone. This is beneficial because ozone destroys microorganisms, rather than simply retarding their growth. Ozone also reacts with and decomposes the ethylene emitted by fresh products, thereby retarding the ripening of the products by reducing their exposure to ethylene. Ozone that is not consumed in these reactions readily decomposes to oxygen, leaving no residue. Because the ozone that is used in refrigerated environments decomposes in these ways over time, the efficacy of its use is limited by both its decomposition rate and by the ability to achieve and maintain a sufficient concentration of ozone in the storage environment surrounding the products. Further, while an effective ozone concentration is needed, an excessive concentration can damage the product. Control of the ozone concentration is therefore critical.

An ozone generator according to the prior art typically has a control panel that is used to turn ozone generation on and off, and to adjust the amount of ozone generated by setting the level of electrical power supplied to the generator. However, a typical ozone generator does not include a means for measuring the amount of ozone delivered to the product in the storage room, so that even when such a generator is run by an experienced operator, the ozone may be delivered in too high a concentration. As a result, product may be “burned,” bleached or otherwise damaged by too high of an ozone dose. On the other hand, ozone doses that are too low or not applied at the right time do not result in adequate product preservation.

Other parameters of the storage room environment, such as temperature, humidity, ethylene concentration, and carbon dioxide concentration, are critical for maintaining product quality, and dictate the optimal effective concentrations of ozone. These parameters change dynamically, and must be responded to dynamically. While it is currently possible to monitor and control the temperature and humidity of the gaseous atmosphere in a storage facility, there appears to be no currently available system for monitoring and altering the composition of gases, including ozone, in the environment to control the state of the product. Also, ozone generators do not enable the adjustment of ozone delivery to optimize preservation of the product based on real-time determination of parameters such as those mentioned above, nor according to a pre-defined program.

In currently available systems, ozone is generally injected continuously based on estimates. Because information from the storage facility (or collected from multiple storage facilities) is not used to dynamically adjust the ozone input and maintain a constant environment, the environment is not truly under control, and does not provide optimized results.

In most currently available systems, an operator activates and monitors ozone production directly at the generator. Adjustments, even if made, are often made too late, and are again based on only estimates of what the levels of adjustments should be, rather than on the quantitative input of conditions measured within the storage facility in real time. In some cases manual adjustments that increase the ozone concentrations result in ozone levels of more than one part per million, which can destroy or burn the product. Also, OSHA regulations prohibit the exposure of workers to ozone levels in excess of 300 ppb without protective gear.

Many storage facilities have multiple storage rooms. In these facilities, ozone is typically made at a central generator and piped to these storage rooms in tubing. Such a system has several disadvantages. For example, the installation of tubing and electrical connections to the rooms is costly, and may be impractical or impossible (as may occur when the rooms are a long distance away from each other or in separate buildings). Running ozone from a central location requires special tubing (such as double-walled tubing or welded stainless steel tubing) to comply with fire codes; again, such tubing is expensive to install. Furthermore, if only a few rooms (for example, less than five) are to be ozonated, the cost per room is relatively high; the fixed cost of a centralized ozone generator and control system requires amortization over many rooms to be cost-effective.

Most ozone generators use ozone cells of the corona discharge type, which provide an economic means for making ozone in amounts sufficient for storage applications. These cells are damaged by humidity in the feed gas, and operate most efficiently when the feed gas is oxygen. Since storage rooms are often kept at a humidity of greater than ninety percent, or are located in crop-producing regions where the ambient temperature or humidity is high, corona discharge ozone cells typically require an air preparation system. The air preparation system may involve fans, compressors, dehumidifiers, oxygen concentrators, and the regulators, valves and gauges needed for pressure and flow control. The air may come from inside or outside the storage room. If the air preparation system uses air from the ozonated room, the ozone in that air can damage the internal components of the air preparation system.

Also, an ozone generator typically uses electronic circuit boards, cables and other electrical components that are not resistant to the corrosive effects of ozone. These components dissipate power and therefore must be cooled, preferably using cooling air from the ambient environment. However, currently available ozone generation systems with air cooling cannot be placed inside an ozonated room, because the corrosive effects of the ozone in the air leads to the corrosion of vital components (such as the electronic circuit boards).

Another disadvantage of currently available room ozonation systems is that if a unit fails: (1) the operator may not be aware of the failure; (2) even if the operator is aware of the failure, the room will likely have no ozone until a repair can be performed; and (3) if insufficient amounts of ozone are supplied to one zone or set of rooms, no means is provided for balancing the ozone demand from other zones or rooms.

For these reasons, currently available ozonation systems do not effectively maintain desirable ozone levels, and do not even monitor the actual level of ozone, nor other parameters relevant to optimizing the ozone level.

### SUMMARY OF THE INVENTION

Embodiments of the present invention provide a distributed networked ozonation system for ozonation of storage rooms containing fresh or perishable products, and may be useful for other applications involving multiple ozonated zones. An exemplary embodiment uses a set of distributed ozone generators connected to a communication network. An exemplary ozone generator comprises an ozone sensor, an ozone-generating cell, and a controller, and also may comprise an air cooling unit with an ozone destruct air filter, so that the generator may be placed within an ozonated environment. The ozone level of the storage area may be under closed-loop feedback control. The controller may communicate with other controllers at the same site and with a site controller, which in turn may communicate with a remote controller.

### BRIEF DESCRIPTION OF THE DRAWINGS

FIG. 1 is a block diagram of an exemplary distributed ozone generator according to an embodiment of the present invention.

FIG. 2 is a block diagram of an exemplary distributed networked ozonation system according to an embodiment of the present invention.

### DETAILED DESCRIPTION OF THE INVENTION

Embodiments of the present invention provide a distributed networked ozonation system for ozonation of storage rooms containing fresh or perishable products. An exemplary embodiment uses a set of distributed ozone generators connected to a communication network, rather than to a centralized ozone generator. The ozone generators may communicate with one or more zone or room ozone sensors, and each ozone generator may supply ozone under closed-loop control to at least one zone or room, or to multiple zones in one or more rooms. The ozone generators may be located inside or in the vicinity of a room, even if operator access to a generator is rare or difficult in its location. The generators may be connected through the network to a site controller and to each other, and may receive information (such as operating parameters) from the site controller or from each other, and/or send information (such as status reports) to the site controller or each other. The site controller may communicate with a remote controller, which may store and retrieve data transmitted from one or more rooms or zones. The remote controller may send instructions to the site controller, and/or directly to one or more room or zone controllers. A room, zone, site or remote controller may provide reports and alerts to any facility operation and equipment service personnel.

Exemplary embodiments provide an aggregate ozonation system comprising sub-systems and sub-assemblies, and provide precise control of ozone dissemination in storage rooms based on feedback comprising parameters sensed within each room. Further, exemplary embodiments network various ozonation sites by incorporating local wired or wireless communications that enable the sites to interact with the control elements of the system; optionally, an internet connection may be incorporated to enable monitoring, communication and control of the system from anywhere in the world.

In an exemplary embodiment, each distributed ozone generator is capable of supplying two adjacent rooms, or two zones in one room. Multiple distributed ozone generators may be used if a facility or site has more than two storage rooms.

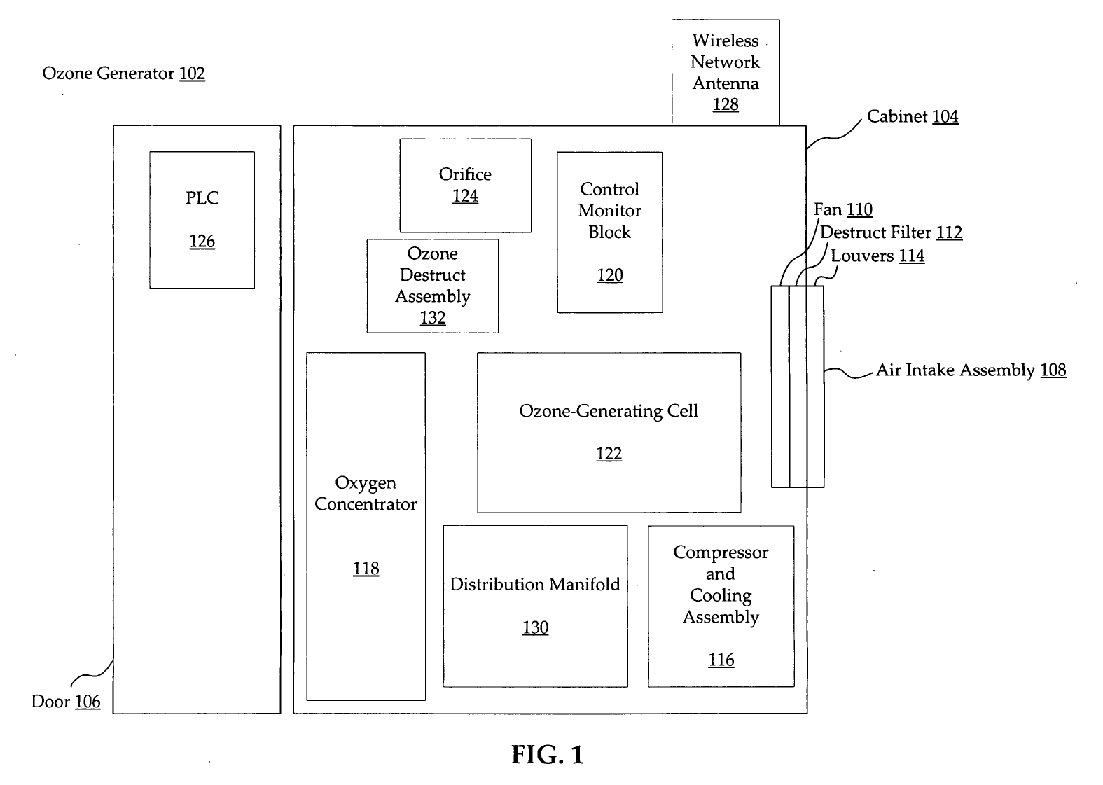

FIG. 1 is a block diagram of an exemplary distributed ozone generator 102 according to one embodiment of the present invention. Distributed ozone generator 102 comprises an air intake assembly 108, a compressor and cooling assembly 116, an oxygen concentrator 118, a control monitor block 120, an orifice 124, a Programmable Logic Controller (“PLC”) 126, a wireless network antenna 128, a distribution manifold 130, and an ozone destruct assembly 132. Distributed ozone generators 102 may have some or all of these components and/or additional components in any combination or configuration and still fall within the scope of the invention.

In some embodiments, the ozone generator is packaged within a cabinet 104 which has a door 106. In one exemplary embodiment, the cabinet 104 is small (e.g., approximately 24 inches by 24 inches by 11 inches, and weighing approximately 120 pounds), is made of stainless steel, and has penetrations, louvers and openings designed to manage air flow through the system, to protect the internal components and to provide thermal management of the internal heat (which may be generated primarily by the compressor 116 and the power supply for the ozone-generating cell 122). The cabinet 104 may be made of stainless steel, and powder coat paint may be used to coat the cabinet 104 (and any door 106), to provide maximum protection from exposure to atmospheric elements and corrosive chemicals such as ozone. A thermocouple (or any other sensor) may be mounted in the cabinet 104, to monitor the cabinet temperature (or other parameters) and report to the PLC 126.

Some embodiments include an air intake assembly 108. At least one fan 110 at the air intake may provide both an air supply to feed the ozone-generating cell 122 and a cooling air flow for the internal components of the generator 102. The fan 110 may be sized specifically to dissipate heat generated by internal components (such as the compressor 116 and the power supply for the ozone-generating cell 122). A destruct filter 112 may be present, which permits the cooling air drawn in through louvers 114 to come from an ozonated storage room or area in which the generator 102 resides, which room or area may be cooled by a refrigeration system; such an arrangement should provide more efficient cooling.

Alternatively, the air supply for the ozone-generating cell 122 may be provided by a tubing connection that may draw air from outside the storage room or area. This mode of operation may be desired if the room is a controlled atmosphere room, which may not contain enough oxygen for efficient ozone generation.

It may be desirable to operate the ozone-generating cell 122 with a gas enriched in oxygen, though this is not required. In some embodiments, the ozone-generating cell 122 operates on air, or on oxygen-depleted gas from a controlled atmosphere room. In one embodiment, the air supplied to the ozone-generating cell 122 may pass through a compressor and cooling assembly 116, and/or an oxygen concentrator 118. Alternatively, the oxygen concentrator 118 may be replaced by a dryer or dehumidifier.

For example, air may be supplied to an ozone-generating cell 122 having a high-frequency power supply and a capacitive discharge device. An ozone-generating cell 122 of the corona discharge type may be used; in one embodiment, the ozone-generating cell 122 has the capacity to produce about 500 grams per day of ozone at eight percent weight/weight, from a gas containing at least ninety percent oxygen, taken in at a flow rate of three liters per minute. One skilled in the art will recognize that different specifications (such as flow and concentration) than those mentioned herein may be appropriate for an ozone-generating cell 122 of a different size from those used in the given examples.

A particle filter may be provided at the intake to the compressor in the assembly 116 to prevent particles larger than, for example, approximately 3 μm from proceeding through the generator 102. Exhaust gas may leave the compressor at a pressure of, for example, approximately 30 pounds of force per square inch gauge (psig), and then may pass through a cooling coil in assembly 116, and into an oxygen concentrator 118.

Alternatively, the assembly 116 may comprise either a compressor or a cooling coil. The generator 102 and any of its components or parts thereof may be made from any suitable material; for example, a cooling coil may be made of aluminum. A cooling coil may reduce the temperature of any hot, compressed gas emanating from the compressor by as much as 30 degrees Celsius prior to entry into the oxygen concentrator 118.

The oxygen concentrator 118 may be of any type. For example, the concentrator 118 may use pressure swing adsorption with molecular sieves to separate air into its major components, resulting in an effluent of oxygen that is at least ninety percent (by volume) pure, at a flow rate of about three liters per minute. Pressure swing between the sieves may be controlled, for example, by using a small printed circuit board (PCB) controller. If desired, a group of valves may route the produced oxygen to an output port and back into the sieve, to purge the sieve of absorbed nitrogen or water. Purged nitrogen then may be passed through a muffler to make the process quieter, and then may be exhausted either into the device cabinet or into the external atmosphere. Output pressure from the oxygen concentrator 118 may be regulated, for example, to about ten psig. The intake tube of the compressor assembly 116 is placed near the air intake assembly 108, or another opening connected to the outside of the cabinet 104, to avoid sucking in air depleted in oxygen and enriched in purged nitrogen.

The oxygen-rich output gas from the oxygen concentrator 118 then may be passed through a control monitor block 120, which may contain a variety of monitoring and controlling components. For example, the block 120 may comprise an upstream pressure regulator with a pressure gauge, a differential pressure transducer positioned across a small orifice (not shown), a relative humidity sensor, and an oxygen sensor. The differential pressure transducer may be designed to monitor flow in the system, and its signals may be monitored continuously by the PLC 126. An oxygen sensor may be included to monitor the concentration of oxygen which should be over ninety percent for most efficient operation of the corona discharge cell 122. Alternatively, or in addition, sensors and actuators monitored by the PLC 126 may be elsewhere within or on the cabinet 104, and/or elsewhere in the distributed networked ozonation system.

Some situations may result in no gas flow, and thus a minimum signal from the pressure transducer. Some of these situations may result in the automatic shutdown of major components of the generator 102 to maintain safety for personnel and to prevent damage to components in the generator 102. For example, if the differential pressure transducer reports a zero pressure difference (or a preset minimum value), this may indicate a compressor failure, blockage of an orifice, blockage or excessive back-pressure at the ozone-generating cell 122, and so on, so the PLC 126 may shut down the compressor 116, the oxygen concentrator 118, and the ozone-generating cell 122. Similarly, if the differential pressure transducer indicates a difference above a maximum value, this also may indicate a leak or valve failure, so the PLC 126 may be programmed to shut down the compressor 116, the oxygen concentrator 118, and the ozone-generating cell 122.

The size of the orifice in block 120 may be designed to produce a pressure drop of usually four psig or less, so that the signal from a typical pressure transducer may be 100 mV to 2 V direct current, the later being roughly in the middle of the transducer's range.

The relative humidity sensor may be used to measure the water content of the output gas from the oxygen concentrator 118. The signals from the humidity sensor also may be monitored by the PLC 126. Excessive humidity may result in lower ozone output, and in some severe cases, clogging of an air gap in the ozone-generating cell 122. Relative humidity above a preset threshold may result in a shutdown of the generator 102 to prevent damage to the ozone-generating cell 122. In addition, if a relative humidity sensor at the input to the ozone-generating cell 122 exceeds a preset value, the oxygen concentrator 118 may have failed, so the PLC 126 may shut down the compressor 116, the oxygen concentrator 118, and the ozone-generating cell 122. An oxygen sensor may be used in a similar manner, with a low oxygen concentration (less than eighty percent) indicating a failure of the oxygen concentrator 118. A trend of decreasing oxygen concentration over a period of time may indicate depletion of the molecular sieve beds in the oxygen concentrator, and need for replacement.

The control monitor block 120 also may comprise a temperature sensor. Thus, if the ozone-enriched gas has a temperature in excess of a preset value (such as 50 degrees centigrade), the PLC 126 may shut down the compressor 116, the oxygen concentrator 118, and the ozone-generating cell 122, and/or any other component of the generator 102. Similarly, the optional thermocouple mounted in the cabinet 104 may be capable of reporting a temperature in excess of a preset value (such as 100 degrees centigrade), so that the PLC 126 may shut down the compressor 116, the oxygen concentrator 118, and the ozone-generating cell 122.

Output gas from the control monitor block 120 then may be fed into an ozone-generating cell 122. Even though the preferred embodiment used a corona discharge reactor, the ozone-generating cell 122 may be of any appropriate type, such as an ozone-generating cell 122 that uses an ultraviolet (UV) light source. The ozone-generating cell 122 should be capable of making sufficient ozone to supply at least one room or zone, preferably with an amount of ozone in the ranges of approximately one to about twenty grams per day for a container of about 4,000 cubic feet, approximately ten to about 250 grams per day for a small storage room of about 4,000 to about 25,000 cubic feet and approximately 100 to about 2000 grams per day for a large storage room of about 25,000 to more than 100,000 cubic feet.

In an exemplary embodiment suitable for a large storage room, the ozone-generating cell 122 may be a corona discharge “flat cell” device having a power supply capable of an input of more than 300 Watts, a dielectric, and an air gap between two substantially parallel high voltage electrodes. Oxygen-rich gas from the oxygen concentrator 118 and/or the control monitor block 120 may be passed though the gap between the dielectric and the ground electrode of the ozone-generating cell 122, and a dielectric barrier discharge across the gap may dissociate the oxygen. The dissociated oxygen may recombine into free oxygen atoms (O), oxygen molecules (O₂), and ozone molecules (O₃). The frequency of the input power may be dictated by the inductive and capacitive elements of the ozone-generating cell 122, and for example, may vary from about fifty or sixty Hz to more than thirty kHz.

An auxiliary fan may provide cooling to any components of the power supply of the ozone-generating cell 122, such as magnetic components. Cooling air for a power supply PCB may be provided by main cooling fans for the entire generator 102. However, in one embodiment, the ozone cell 122 is cooled not by air but by water.

Ozone-enriched gas from the ozone-generating cell 122 may be passed through a flow restrictor, such as an orifice 124. The size of the orifice 124 may be designed to maintain a specific back-pressure, so that the average pressure in the ozone-generating cell 122 is maintained at a desired value. The temperature of the ozone-enriched gas also may be measured near (for example, just upstream of) the orifice 124 by a thermocouple (such as a type K thermocouple) immersed in the gas stream. This temperature may be monitored by the PLC 126, so that, for example, if the temperature of the ozone-enriched gas exceeds a pre-set value, the PLC 126 may produce an alert message and/or shut down the generator 102.

The PLC 126 may provide overall control of the generator 102. The PLC 126 may be capable of reading sensors, providing precise control of the ozone output, and of performing a safety shutdown of the generator 102 or any of the components thereof if personnel, product and/or equipment are threatened (for example, by failure of a critical system component). A network transceiver (such as a wireless network antenna 128) may enable communication between the ozone generator 102 and a site controller, and/or among two or more ozone generators 102.

The ozone-enriched gas may be passed into an output distribution manifold 130 comprising various valves. In an exemplary ozone generator 102 that can supply at least two rooms or zones that are independently controlled, one valve for each room or zone may be provided to pass the ozone-enriched gas into the respective cold storage areas. An additional valve may pass excess ozone-enriched gas through an in-line ozone destruct assembly 132, and yet another valve may be an auxiliary input/output port. An auxiliary port may be used for many purposes, such as: to supply ozone to another ozone generator 102; to receive ozone from another ozone generator 102 (for example, in the event of some failure or increased ozone demand); and/or to supply an additional room (with appropriate sensors and control logic optionally added).

The distribution manifold 130 (or valve system) may be especially useful for controlling ozone concentrations in cold storage rooms containing fruits, vegetables and food products, since turning valves on and/or off allows closed-loop control of ozone concentrations in independently controlled zones (a “zone” may be a part of one room, an entire room, or a group of rooms). In some embodiments, all valves normally may be closed, except for a valve to an in-line ozone destruct assembly 132 that normally may be open.

An ozone destruct filter 112 may remove ozone from the cooling air, and from the input air that is to be prepared for the ozone-generating cell 122. Also, directing some of the output flow from the ozone-generating cell 122 to an ozone destruct assembly 132 may be useful for maintaining stable flows and/or stable operation of the ozone-generating cell 122 when the ozone concentration in the room is at the desired level, without the need for shutting down the ozone-generating cell 122 and/or the air preparation process. In some embodiments, the in-line destruct ozone destruct assembly 132 comprises a tube filled with Carulite material (that acts as a catalyst to convert ozone to oxygen) and mounted inside the cabinet 104.

In an exemplary embodiment, the in-line ozone destruct assembly 132 is an aluminum cylinder that is six inches long, has an internal diameter of two inches, and is filled with granular Carulite material. After passing through the ozone destruct assembly 132, the gas may be released safely into the atmosphere. One having ordinary skill in the art readily will be able to determine the appropriate amount and packing density of the fill material for a column in the ozone destruct assembly 132, the physical dimensions of the ozone-destruct column, and other parameters needed to destroy the desired amount of ozone concentrations and amounts produced by a specific ozone generator 102.

Similarly, an ozone-destruct filter 112 may remove ozone from the air pulled from the external environment at the air intake 108. The destruct filter may be constructed using material capable of converting ozone to oxygen, or reacting with ozone and thus removing ozone; examples of such materials are activated charcoal, titanium dioxide, and/or Carulite. An ultraviolet light source may be used, instead or as well, to destroy ozone.

In addition to the ozone generator 102, an exemplary distributed networked ozonation system according to one embodiment of the present invention comprises ozone sensors for monitoring the ozone concentrations within the rooms or zones ozonated by the system. Other kinds of sensors also may be used.

For example, ozone in one or more zones may be measured by the sensors, which may report measurements to the controller PLC 126. An ozone sensor may be of any kind, such as the electrochemical type or the ultraviolet light-based type. The controller PLC 126 may maintain a constant concentration of ozone by opening and closing distribution valves in the manifold 130, routing the ozone-enriched gas to one or more zones within one or more rooms, to one or more rooms or sets of rooms, to the auxiliary port, and/or to the ozone destruct assembly 132, depending on the ozone sensor measurements. If only one room is supplied by an ozone generator 102, the amount of ozone into the room may be controlled by adjusting the power setting of the ozone-generating cell 122 while the valve to the room stays open.

If desired for safety reasons, if the ozone concentration in a cold storage room exceeds a preset value (which may indicate a valve failure, a sensor failure, that the system is “out of control,” and so on), the PLC 126 may shut down the compressor 116, the oxygen concentrator 118, the ozone-generating cell 122, and all of the valves in the distribution manifold 130. Similarly, if an ozone sensor in a cold storage room continuously reports a zero (or a minimum threshold preset value) even though ozone is admitted into the room, this may indicate that a sensor has failed, a sensor pump has failed, the ozone output from the ozone-generating cell 122 is too low, and/or the output from the oxygen concentrator 118 is too low. Since the real cause for such a report would be unknown, the PLC 126 may shut down the compressor 116, the oxygen concentrator 118, and the ozone-generating cell 122.

The ozone generator 102 also may comprise an ambient ozone monitor (that may be integrated within the cabinet), which may monitor the ozone concentration in the local atmosphere in and surrounding the generator. This may be desired for safety reasons. For example, because ozone is a very reactive chemical compound, it is desirable for the ozonation system to be capable of protecting personnel from ozone exposure that would fall outside the OSHA guidelines for ozone exposure time and concentration. Also, it is desirable to protect the ozonation system itself from ozone concentrations that would cause corrosion of system components. The ozone monitor(s) may provide feedback signals that inform the PLC 126, so that the PLC 126 may control the safety response of the system. Thus, if the ozone concentration within the cabinet 104 or the local atmosphere exceeds a preset limit (which may indicate a leak, a valve failure or a failure of the ozone destruct assembly 132, for instance), the monitor may signal the PLC 126, which may shut down the compressor 116, the oxygen concentrator 118, and the ozone-generating cell 122.

An emergency shutoff button also may be associated with the ozone generator 102. The emergency off button may be placed in an accessible location, even if the generator 102 is mounted in a place that is not easily accessible, such as high on a storage room wall or ceiling.

Ozone generators 102 may be operated manually, locally or remotely through a wireless network or the internet, for example, using a computer communicating with the PLC 126. If more than one ozone generator 102 is present at a site, the ozone generators 102 may be in communication with each other through a network. Ozone generators 102 also may be connected by their auxiliary ports for ozonated gas. Ozone generators 102 may be linked to each other in any combinations of two or more units.

For example, one might have a site with two buildings, the first building having five rooms supplied by three ozone generators 102, and the second building having four rooms supplied by two ozone generators 102. All five ozone generators 102 at the site may be in communication with each other and with a site controller (discussed below). The three ozone generators 102 in the first building may have a gas connection link through their auxiliary ports, as may the two ozone generators 102 at the second building. Such a configuration may offer several important benefits, such as: satisfying peak ozone demand (if a room temporarily needs more ozone than its generator 102 provides, then additional ozone may be provided by one of the linked ozone generators 102); load-balancing (if the rooms have different ozone demands (for example, if they are of different sizes, or contain different products), the total available ozone may be allocated among the rooms to satisfy the ozone demand of each room); and providing redundancy (if one ozone generator 102 were to fail, ozone may be supplied by another generator 102).

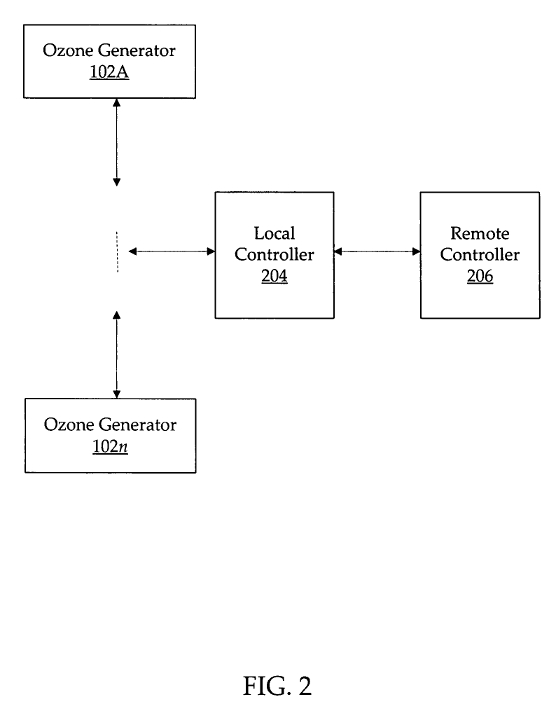

FIG. 2 is a block diagram of an exemplary distributed networked ozonation system according to one embodiment of the present invention. The distributed ozone generators 102 are linked to each other through a computer network (such as a wireless network using Bluetooth or WiFi), forming a network such as a local area network or a peer-to-peer mesh network. The distributed ozone generators 102 are also in communication with a conveniently located local controller (or “site controller”) 204 (such as a personal computer). The local controller 204 may provide centralized management of one or more ozone generators 102, reduced installation costs, load-balancing among generators 102, and increased reliability of the distributed networked ozonation system.

The local controller 204 may be in communication with a remote controller 206 through a wired or wireless network. For example, the remote controller 206 may be connected to the site controller 204 via the internet. If the local controller 204 and remote controller 206 are disconnected from each other temporarily, the site controller 204 may store information and be synchronized with the remote controller 206 upon re-connection.

The remote controller 206 may govern the performance of one or more site controllers 204, and thus may be called a “central” controller, or hub for an entire distributed networked ozonation system. The remote controller 206 may provide centralized management of multiple sites and local controllers 204, by performing a variety of tasks like data logging, data analysis, report generation, and generating alerts. More layers of control (such as a controller that governs one or more remote controllers 206) may be added; a distributed networked ozonation system with any number of layers of control falls within the scope of the invention.

Alerts may be particularly useful for purposes such as: informing an operator or service engineer of a hardware failure; informing an operator or service engineer of a loss of communication that may compromise safety or efficacy of storage; and/or informing an operator or service engineer if gas concentration set points for ozone, oxygen and/or carbon dioxide in a room are not reached or are exceeded. Alerts may be accomplished by various means, such as: sending an e-mail; sending a text message to a mobile phone; sending a message to a pager; and/or automatically calling one or more prescribed phone numbers. A set of rules may be defined to select the alert message, and to provide for escalation if the initial alert is unacknowledged.

The remote controller 206 also may perform analysis of stored data (such as determining product quality and yield at different storage conditions), and may download recipes for optimized control of a storage environment. The remote controller 206 thus may provide the ability to control the ozone generators 102 at various sites from anywhere in the world.

The concentration of ozone in each room or zone served by the system may be monitored using ozone detectors or sensors, as mentioned above. One detector may be used for each zone, or multiple zones may be connected to one detector (for example, via a manifold with multiple inputs). The ozone sensor(s) may be in communication with the PLC 126, and the ozone level may be adjusted based on closed-loop feedback control by the PLC 126.

The ozone level in a room or zone may be adjusted by any method. In some embodiments the power to one or more ozone-generating cells 122 may be controlled, so that just enough ozone is made to maintain a desired concentration level. This control method may be most desirable when the system serves a single room or zone. Alternatively, the concentration level may be constant, but gas containing ozone may be admitted to the room in a pulsed mode, similar to the way a thermostat controls a home heating system. This control method may be most desirable when the system serves multiple zones or rooms. A combination of both methods may be desirable to increase the efficiency of and reduce wear on the valves in a distribution manifold 130 by reducing the frequency of on-off cycles. It may also be desirable to adjust the ozone levels in the room according to a time-based program. A time-based program may have different ozone levels for day and night, or ozone may be alternating between a high concentration and a low concentration periodically to achieve an enhanced disinfection or ethylene reduction benefit.

In addition to ozone concentration, other parameters of a room environment, such as carbon dioxide concentration, temperature, oxygen level, and fluorescence from plant tissues in the room, also may be measured and used by the distributed networked ozonation system to control the concentrations of ozone, oxygen, carbon dioxide, or other gases in the room to protect product quality.

For example, increased carbon dioxide levels may indicate increased respiration, and/or ripening caused by high ethylene levels. Thus, if an increase in carbon dioxide level is detected, the ozone concentration may be increased to reduce the amount of ethylene in the room. The carbon dioxide level also may be reduced to avoid exposure of the product in the room to excessive carbon dioxide, which may damage the product, as may excessive humidity in the room.

In another example, upon a detected temperature increase, ozone levels may be increased automatically to provide additional protection for the product in the room.

In a further example, plant tissue fluorescence (as may be measured with a sensor, such as the HarvestWatch system provided by Satlantic, Halifax, Canada) may indicate stress to the product plant tissue. Thus, if such stress is detected, a PLC 126, a site controller 204 or remote controller 206 may notify a system operator to increase the oxygen level. Alternatively, if a PLC 126, site controller 204 and/or remote controller 206 is in communication with a controlled atmosphere system, the oxygen level in the room may be increased automatically.

The combination of an ozonation system and a plant tissue fluorescence monitor system may be particularly desirable for controlled atmosphere rooms. Storage at a low oxygen level may benefit fruit quality, such as by helping to maintain internal fruit pressure and to avoid scald. A plant tissue fluorescence monitor system may allow the oxygen in the controlled atmosphere room to be set to the lowest level possible to avoid the dominance of anaerobic processes in the product (such as apples). Ozone admitted into the room at the same time may provide a reduction in mold and decay, as well as food safety enhancement, by killing microorganisms and preventing their spread. Ozone also may further increase storage and shelf life by reacting with ethylene in the room.

The distributed networked ozonation system also may comprise visible and audible indicators for a room or zone, which may provide a variety of signals. For example, an indicator may signal that the ozone levels are at a desired set point, and/or that it is safe (or not safe) for personnel to enter an area. An indicator may be of any reasonable type, such as a light bar with red, yellow and green LED lights (or any other combination of colors, lights, and/or sounds).

While various embodiments have been described above, it should be understood that they have been presented by way of example only, and not limitation. For example, while some embodiments are particularly useful for cold storage, the application to cold storage is exemplary and not limiting. Of course, the exemplary components comprising the generator 102 described herein may occur in any appropriate number and order, and other components may be added, as will be recognized by one skilled in the art. Thus, the breadth and scope of a preferred embodiment should not be limited by any of the above-described exemplary embodiments.

What is claimed is:

1. A distributed networked ozonation system, comprising:
at least one ozone generator;
at least one ozone sensor in communication with the ozone generator;
at least one generator controller controlling the ozone generator.

2. The system of claim 1, wherein the ozone generator further comprises an ozone-generating cell.

3. The system of claim 2, wherein the ozone-generating cell is of the corona-discharge type.

4. The system of claim 1, wherein the ozone generator further comprises an air-intake assembly.

5. The system of claim 4, wherein the air-intake assembly further comprises a fan and an ozone-destruct filter.

6. The system of claim 1, wherein the ozone generator further comprises an air compressor.

7. The system of claim 1, wherein the ozone generator further comprises an air cooling assembly.

8. The system of claim 1, wherein the ozone generator further comprises an oxygen concentrator.

9. The system of claim 1, wherein the ozone generator further comprises a control monitor block.

10. The system of claim 1, wherein the ozone generator further comprises an orifice.

11. The system of claim 1, wherein the generator controller is a programmable logic controller.

12. The system of claim 1, wherein the generator controller is in communication with the ozone sensor.

13. The system of claim 1, wherein the generator controller is in communication with a computer network.

14. The system of claim 1, wherein the ozone generator further comprises a gas distribution manifold.

15. The system of claim 1, wherein the ozone generator further comprises an ozone destruct assembly.

16. A distributed networked ozonation system, comprising:
at least one ozone generator;
at least one ozone sensor in communication with the at least one ozone generator, the at least one ozone sensor configured to monitor ozone concentration in a storage area for a perishable product;
at least one generator controller configured to control the ozone generator; and
a closed-loop feedback in communication with the at least one ozone sensor and configured to control the ozone concentration in the storage area.

17. The system of claim 16, further comprising at least one local controller configured to transmit data or an instruction to the at least one generator controller.

18. The system of claim 17, wherein the at least one generator controller is configured to transmit an operating parameter or a status report to the local controller.

19. The system of claim 16, further comprising a remote controller configured to transmit data or an instruction to the generator controller.

20. The system of claim 17, wherein the at least one local controller is further configured to transmit an alert.

21. The system of claim 17, further comprising a fluorescence sensor in communication with the local controller.

22. The system of claim 17, further comprising a carbon dioxide sensor in communication with the local controller.

23. The system of claim 17, further comprising an oxygen sensor in communication with the local controller.

24. The system of claim 17, further comprising an ethylene sensor in communication with the local controller.

25. The system of claim 17, further comprising a temperature sensor in communication with the local controller.

26. The system of claim 17, further comprising a relative humidity sensor in communication with the local controller.

27. The system of claim 16, further comprising a gas connection between the at least one ozone generator and a second ozone generator.
